(19) United States
(12) Patent Application Publication
(10) Pub. No.: US 2008/0307428 A1
(43) Pub. Date: Dec. 11, 2008

(54) IMAGE FORMING APPARATUS, APPLICATION EXECUTION METHOD, AND STORAGE MEDIUM

(76) Inventors: Aritaka HAGIWARA, Kanagawa (JP); Tadashi NAGATA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/106,728

(22) Filed: Apr. 21, 2008

(30) Foreign Application Priority Data
Jun. 5, 2007 (JP) 2007-149386

(51) Int. Cl. G06F 9/46

(52) U.S. Cl. 718/106

(57) ABSTRACT

A disclosed image forming apparatus includes a storage unit storing a linkage application and processing applications, each of the processing applications being implemented by a combination of software components for inputting, processing, and outputting image data. The linkage application is configured to execute a combination of the processing applications in sequence.

### BACKGROUND OF THE INVENTION

1. Field of the Invention

The present invention generally relates to an image forming apparatus, an application execution method, and a storage medium containing program code for performing the application execution method.

2. Description of the Related Art

Nowadays, an image forming apparatus, although with limited memory, normally has a configuration similar to that of a general purpose computer where functions are implemented by a CPU and applications. Such image forming apparatuses include a printer, a copier, a scanner, a fax machine, and a multifunction copier having functions of these apparatuses.

Patent document 1 discloses an image forming apparatus where common functions used by multiple applications are provided as a platform and applications can be implemented using application programming interfaces (APIs) provided by the platform. Having common functions as a platform in turn eliminates the need to develop those functions for each application and therefore improves efficiency of application development.

[Patent document 1] Japanese Patent No. 3679349

One difficulty in providing common functions or APIs as a platform in an image forming apparatus is to appropriately design the granularity of the functions or APIs in the platform. If the granularity is not designed properly, improvement in application development efficiency may not be expected.

For example, too fine granularity makes it necessary to call many APIs even from a simple application and therefore complicates source code of the application.

On the other hand, too coarse granularity increases the chance of having to modify an API in a platform or add a new API to the platform when developing an application and therefore reduces development efficiency. Especially, when the dependency between modules or APIs in the platform is high, modifying or adding an API may make it necessary to also modify dependent APIs.

Also, with the technology disclosed in patent document 1, it is not possible to implement a new application by calling an existing application that is partly different (for example, in its image input process) from the new application. In other words, it is necessary to write source code from the scratch even when developing an application similar to an existing application.

### SUMMARY OF THE INVENTION

Embodiments of the present invention provide an image forming apparatus, an application execution method, and a storage medium containing program code for performing the application execution method that solve or reduce one or more problems caused by the limitations and disadvantages of the related art.

An embodiment of the present invention provides an image forming apparatus that includes a storage unit storing a linkage application and processing applications, each of the processing applications being implemented by a combination of software components for inputting, processing, and outputting image data; wherein the linkage application is configured to execute a combination of the processing applications in sequence.

Another embodiment of the present invention provides a method of executing applications in an image forming apparatus where each of the applications is implemented by a combination of software components for inputting, processing, and outputting image data. The method includes a linkage step of executing a combination of the applications in sequence.

Still another embodiment of the present invention provides a storage medium storing program code for causing an image forming apparatus to execute applications each of which is implemented by a combination of software components for inputting, processing, and outputting image data. The program code includes a linkage code unit configured to execute a combination of the applications in sequence.

### BRIEF DESCRIPTION OF THE DRAWINGS

FIG. 1 is a drawing illustrating a software configuration of a multifunction copier 1 according to an embodiment of the present invention;

FIG. 2 is a drawing illustrating a pipes-and-filters architecture;

FIG. 3 is a table showing exemplary filter combinations that constitute functions of the multifunction copier 1;

FIG. 4 is a drawing illustrating a configuration of a ScanToEmail activity;

FIG. 5 is a drawing illustrating components of a filter;

FIG. 6 is a drawing illustrating components of an activity;

FIG. 7 is a drawing illustrating a class structure of activities and filters according to a first embodiment of the present invention;

FIG. 8 is a sequence chart showing an initialization process of activities;

FIG. 9 is a sequence chart showing an execution process of a document processing activity;

FIG. 10 is a drawing illustrating a ScanToStorage setting screen;

FIG. 11 is a schematic diagram illustrating filters connected by pipes;

FIG. 12 is a table showing correspondence between filters and pipes;

FIG. 13 is a sequence chart showing an execution process of a linkage activity;

FIG. 14 is a drawing showing linkage definition information of a linkage activity;

FIG. 15 is a drawing illustrating a ScanToEmail setting screen;

FIG. 16 is a flowchart showing an execution process of a linkage activity;

FIG. 17 is a drawing illustrating a class structure of activities and filters according to a second embodiment of the present invention;

FIG. 18 is a drawing illustrating a class structure of activities and filters according to a third embodiment of the present invention;

FIG. 19 is an object diagram illustrating a relationship between a linkage activity and document processing activities according to the third embodiment of the present invention; and

FIG. 20 is a drawing illustrating a class structure of activities and filters according to a fourth embodiment of the present invention.

### DESCRIPTION OF THE PREFERRED EMBODIMENTS

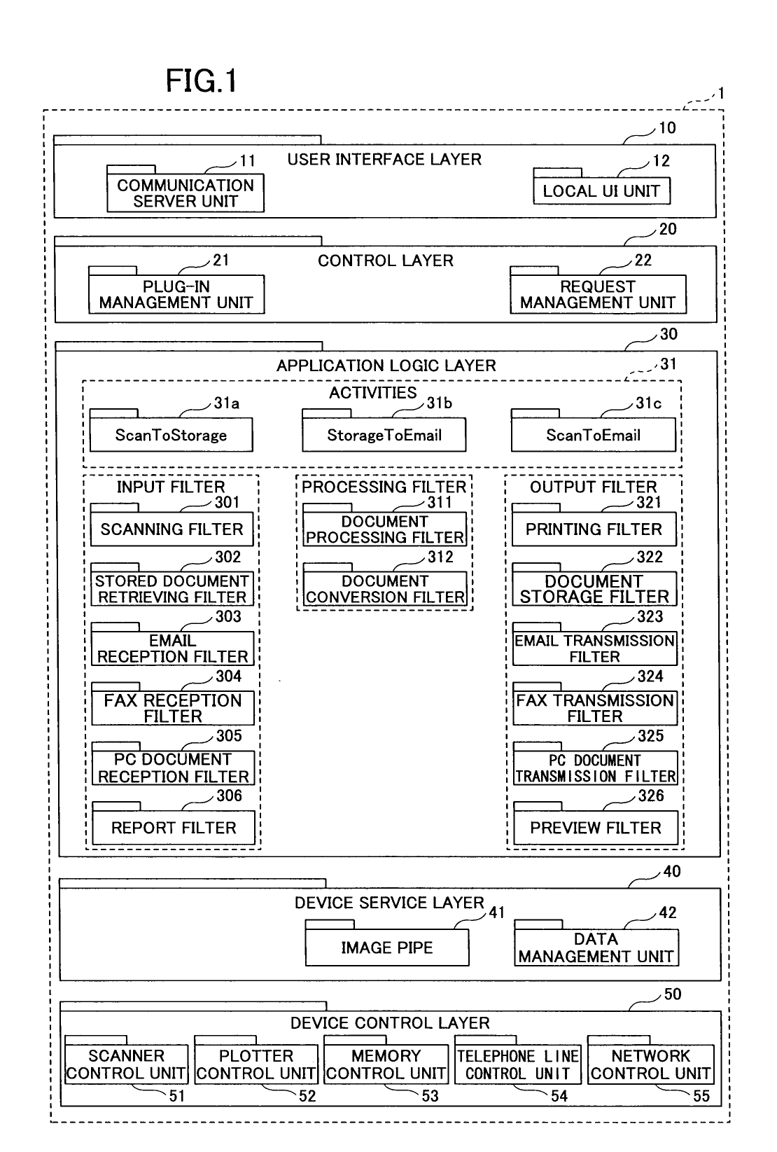

Preferred embodiments of the present invention are described below with reference to the accompanying drawings. FIG. 1 is a drawing illustrating a software configuration of a multifunction copier 1 according to an embodiment of the present invention. In the present application, a “multifunction copier” indicates an image forming apparatus including functions of a printer, a copier, a scanner, and a fax machine.

As shown in FIG. 1, the multifunction copier 1 includes a user interface layer 10, a control layer 20, an application logic layer 30, a device service layer 40, and a device control layer 50. In FIG. 1, layers are arranged in a hierarchical order where a higher layer calls a lower layer. The layers 10, 20, 30, 40, and 50 or components of the layers are, for example, stored in a storage unit of the multifunction copier 1.

The user interface layer 10 includes interfaces that receive execution requests to execute functions such as copying, printing, scanning, and fax transmission. For example, the user interface layer 10 includes a communication server unit 11 and a local user interface (UI) unit 12. The communication server unit 11 receives requests via a network from a client PC (not shown). The local UI unit 12 receives requests input from an operations panel (not shown). Requests received by the user interface layer 10 are forwarded to the control layer 20.

The control layer 20 controls execution processes of requested functions and includes a plug-in management unit 21 and a request management unit 22. The plug-in management unit 21 controls initialization processes (plug-in processes) for making activities 31 and filters in the application logic layer 30 ready for use. The request management unit 22 controls execution processes of functions of the multifunction copier 1 according to requests received by the user interface layer 10. In this embodiment, a “function” of the multifunction copier 1 indicates a service (a sequence of processes from input of a request to output of the result) provided by the multifunction copier 1 for the user or an application executed by the multifunction copier 1 to provide the service.

The application logic layer 30 includes software components that constitute functions provided by the multifunction copier 1. In other words, in the multifunction copier 1, a function is implemented by a combination of software components in the application logic layer 30. In a software architecture called “pipes-and-filters” of the multifunction copier 1 of this embodiment, those software components are called “filters”.

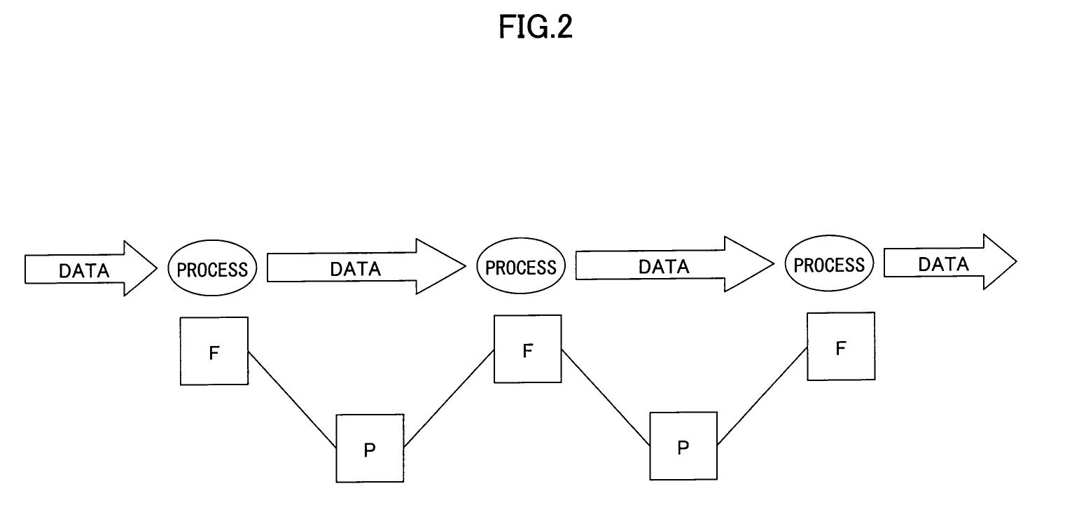

FIG. 2 is a drawing illustrating a pipes-and-filters architecture. In FIG. 2, “F” indicates a filter and “P” indicates a pipe. As shown in FIG. 2, filters are connected by pipes. Each filter processes input data and outputs the result. Each pipe passes data output from a preceding filter to a subsequent filter.

In other words, in the multifunction copier 1 of this embodiment, a function is a series of processes performed by filters on a document (or data). In a sense, each function of the multifunction copier 1 can be generalized as a combination of input, processing, and output processes. Each of the input, processing, and output processes is implemented by a software component, i.e., a filter. An “input filter” inputs data from a device, a “processing filter” performs processing (e.g., image processing) on the input data, and an “output filter” outputs the processed data to a device. Filters are basically independent from each other, i.e., there is substantially no dependency between filters. Therefore, filters can be added (installed) and deleted (uninstalled) without taking into account their dependency.

Referring back to FIG. 1, the application logic layer 30 includes input filters such as a scanning filter 301, a stored document retrieving filter 302, an email reception filter 303, a fax reception filter 304, a PC document reception filter 305, and a report filter 306.

The scanning filter 301 controls the process of scanning an image by a scanner and outputs the scanned image data. The stored document retrieving filter 302 retrieves document data (image data) stored in a storage unit of the multifunction copier 1 and outputs the retrieved document data. The email reception filter 303 receives an email message and outputs data in the received email message. The fax reception filter 304 receives a fax message and outputs data of the received fax message. The PC document reception filter 305 receives print data from a client PC (not shown) and outputs the received print data. The report filter 306 retrieves setting information and history information of the multifunction copier 1 and outputs the information, for example, in a tabular format.

As processing filters, the application logic layer 30 includes a document processing filter 311 and a document conversion filter 312. The document processing filter 311 performs image processing such as N-up processing or resizing (enlargement or reduction) on input data and outputs the processed data. The document conversion filter 312 converts (or renders) input PostScript data into bitmap data and outputs the bitmap data.

As output filters, the application logic layer 30 includes a printing filter 321, a document storage filter 322, an email transmission filter 323, a fax transmission filter 324, a PC document transmission filter 325, and a preview filter 326.

The printing filter 321 prints (outputs) input data on a plotter. The document storage filter 322 stores input data in a hard disk of the multifunction copier 1. The email transmission filter 323 attaches input data to an email message and sends the email message. The fax transmission filter 324 sends input data as a fax message. The PC document transmission filter 325 sends input data to a client PC. The preview filter 326 displays a preview image of input data on the operations panel of the multifunction copier 1.

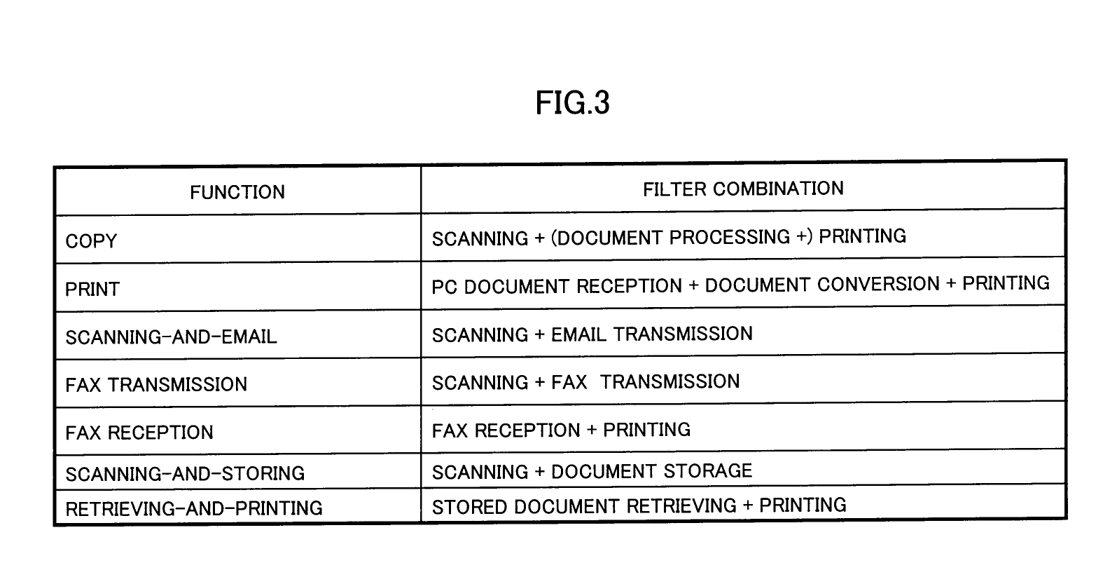

Functions of the multifunction copier 1 are implemented by combinations of filters. FIG. 3 is a table showing exemplary filter combinations that constitute functions of the multifunction copier 1.

For example, a copy function comprises the scanning filter 301 and the printing filter 321. When the copy function is executed, the scanning filter 301 scans a document to obtain image data and the printing filter 321 prints the obtained image data. If image processing such as N-up processing, enlargement, or reduction is requested for the copy function, the document processing filter 311 is inserted between the scanning filter 301 and the printing filter 321.

A print function (for printing print data sent from a client PC) comprises the PC document reception filter 305, the document conversion filter 312, and the printing filter 321. A scanning-and-email function (for scanning an image and sending the scanned image as an email message) comprises the scanning filter 301 and the email transmission filter 323. A fax transmission function comprises the scanning filter 301 and the fax transmission filter 324. A fax reception function comprises the fax reception filter 304 and the printing filter 321. A scanning-and-storing function (for scanning an image and storing the scanned image in the multifunction copier 1) comprises the scanning filter 301 and the document storage filter 322. A retrieving-and-printing function (for retrieving document data in the multifunction copier 1 and printing the document data) comprises the stored document retrieving filter 302 and the printing filter 321.

Note that the scanning filter 301 is used in five functions in FIG. 3. Thus, in this embodiment, each filter can be used as a component of multiple functions. This architecture reduces the workload of developing functions. Also, this architecture makes it possible to use one user interface for multiple functions. For example, many execution conditions of the copy function and the scanning-and-storing function can be set up by using a common user interface. In the multifunction copier 1 of this embodiment, a user interface for the scanning filter 301 can be used for both the copy function and the scanning-and-storing function. If functions are developed as dedicated applications as in a conventional image forming apparatus, user interfaces must be developed for the respective applications.

With the multifunction copier 1, the user can easily create a new function. Take, for example, a case of creating a function 1 for printing print data that are sent from a client PC and described in a page description language (PDL) not supported by the multifunction copier 1 (hereafter the PDL is called unsupported PDL). The function 1 may be created based on the print function shown in FIG. 3. The PC document reception filter 305 used in the print function is supposed to receive and output print data in the PostScript format that can be handled by the document conversion filter 312. However, in the function 1, the PC document reception filter 305 receives and outputs print data in the unsupported PDL format that cannot be handled by the document conversion filter 312. This problem can be solved by creating a conversion filter (hereafter called a PDL-to-PS conversion filter) and inserting the PDL-to-PS conversion filter between the PC document reception filter 305 and the document conversion filter 312. Thus, the function 1 can be implemented by connecting the PC document reception filter 305, the PDL-to-PS conversion filter, the document conversion filter 312, and the printing filter 321.

Take, for another example, a case of developing a function 2 for collecting information from a Web site and printing the collected information. The function 2 can be implemented by creating a new input filter (Web-information collecting filter) for collecting information from a Web site and by interfacing the Web-information collecting filter and the printing filter 321. To interface the Web-information collecting filter and the printing filter 321, it is necessary to convert collected Web information into bitmap data that the printing filter 321 can receive. Because incorporating a rendering capability in the Web-information collecting filter requires a heavy workload, it is preferable to use the document conversion filter 312 to render collected Web information into bitmap data. The Web-information collecting filter and the document conversion filter 312 can be connected by just modifying the Web-information collecting filter to be able to output collected Web information in the PostScript format. Thus, the function 2 can be implemented by connecting the Web-information collecting filter, the document conversion filter 312, and the printing filter 321.

As described above, functions of the multifunction copier 1 are implemented by combinations of filters, and this architecture makes it easier to customize and add functions Also, because there is substantially no functional dependency between filters, it is possible to easily develop a new function (or an application) by adding a new filter or changing the combination of filters. In other words, with the multifunction copier 1 of this embodiment, it is possible to create a new application by just developing a filter that performs a process unique to the new application. This in turn reduces the chance of having to modify software components in the layers above and below the application logic layer 30 when creating a new application and thereby makes it possible to provide a stable platform.

The application logic layer 30 includes activities 31 in addition to the filters. An “activity” indicates a piece of software or an application that implements a function (or a service) of the multifunction copier 1 by a combination of filters.

The multifunction copier 1 allows the user to dynamically create a function (an application) by combining independent filters. For example, the multifunction copier 1 may be configured to request the user to select filters and to specify the execution sequence and conditions of the filters via an operations panel each time execution of a function is requested by the user.

However, it is bothersome for the user to select filters each time to execute a frequently used function such as a copy function. This problem can be solved by using “activities”. In this embodiment, combinations of filters can be defined as the activities 31, and the user can execute a function by selecting one of the activities 31. When one of the activities 31 is selected, the multifunction copier 1 automatically executes a combination of filters defined in the selected activity 31. Thus, the activities 31 allow the user to perform tasks as simply as with a conventional image forming apparatus where functions are provided as separate applications.

In FIG. 1, a ScanToStorage activity 31a, a StorageToEmail activity 31b, and a ScanToEmail activity 31c are shown as examples of the activities 31.

The ScanToStorage activity 31a implements a function to scan and store a document by a combination of the scanning filter 301, the document processing filter 311, and the document storage filter 322.

The StorageToEmail activity 31b implements a function to send a stored document as an email message by a combination of the stored document retrieving filter 302, the document processing filter 311, and the email transmission filter 323.

The ScanToEmail activity 31c links (or combines) the ScanToStorage activity 31a and the StorageToEmail activity 31b and executes the two activities 31 in sequence. Thus, an activity may also comprise a combination of activities.

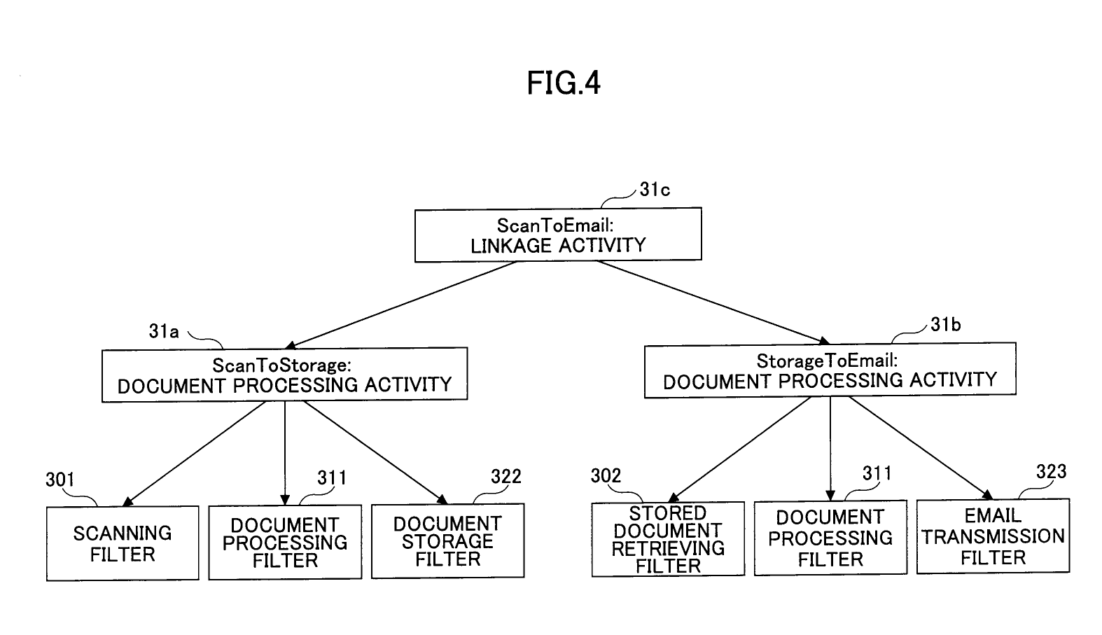

FIG. 4 is a drawing illustrating a configuration of the ScanToEmail activity 31c. As shown in FIG. 4, the ScanToEmail activity 31c calls the ScanToStorage activity 31a and the StorageToEmail activity 31b, and the ScanToStorage activity 31a and the StorageToEmail activity 31b, respectively, call their constituent filters.

In this embodiment, an activity like the ScanToEmail activity 31c comprising multiple activities is called a “linkage activity” or a “linkage application”. In contrast to linkage activities, activities like the ScanToStorage activity 31a and the StorageToEmail activity 31b comprising filters are called “document processing activities”. When the distinction is not important, they may be just called the activities 31.

The activities 31 other than linkage activities are basically independent from each other, i.e., there is substantially no dependency between the activities 31. In other words, the activities 31 can be added (installed) and deleted (uninstalled) without taking into account their dependency. The user can freely create and install new activities 31 by combining filters.

The device service layer 40 includes an image pipe 41 and a data management unit 42 that are low-level functions shared by the activities 31 and the filters of the application logic layer 30. The image pipe 41 functions as a pipe described above. The image pipe 41 passes data output from a preceding filter to a subsequent filter. The data management unit 42 represents various databases such as a user information database and a document (or image) database.

The device control layer 50 includes program modules called drivers for controlling hardware devices. For example, the device control layer 50 includes a scanner control unit 51, a plotter control unit 52, a memory control unit 53, a telephone line control unit 54, and a network control unit 55 for controlling respective devices indicated by their names.

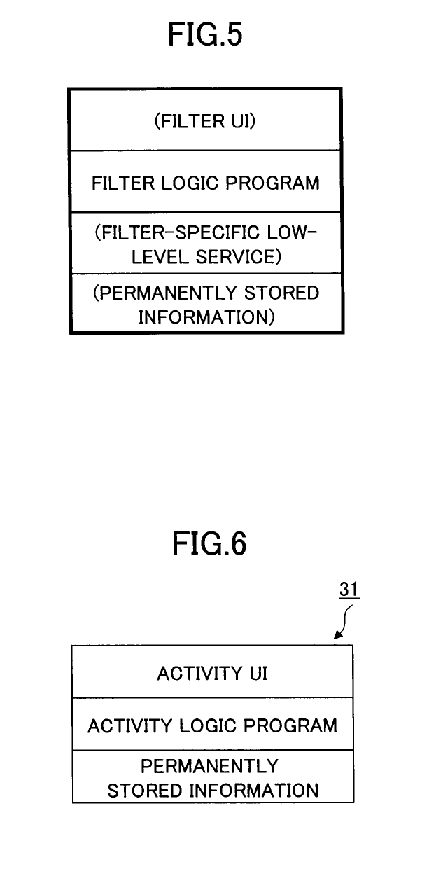

Filters and the activities 31 are described below in more detail. FIG. 5 is a drawing illustrating components of a filter. As shown in FIG. 5, a filter includes a filter UI, a filter logic program, a filter-specific low-level service, and permanently stored information. The filter UI, the filter-specific low-level service, and the permanently stored information are optional components.

The filter UI is a program for displaying a screen for setting execution conditions of the filter, for example, on an operations panel. For example, the filter UI of the scanning filter 301 displays a screen for setting a resolution, a density, and an image type. The filter UI may be implemented as hypertext markup language (HTML) data or scripting language data to be displayed on the operations panel.

The filter logic program performs the task of a filter or defines a process to be performed by the filter. The filter logic program performs the task of a filter by using a filter-specific low-level service of the filter, a low-level function in the device service layer 40, and/or a driver in the device control layer 50 according to execution conditions specified via the filter UI. For example, the filter logic program of the scanning filter 301 controls the process of scanning an image by a scanner.

The filter-specific low-level service is a library used by the filter logic program. The filter-specific low-level service provides a filter-specific function that is used only by a filter. Otherwise, the filter-specific low-level service is similar to a low-level function in the device service layer 40 or a driver in the device control layer 50. In other words, if a filter can perform its task using a shared low-level function or driver, the filter-specific low-level service may be omitted. For example, the scanning filter 301 can perform its task using the scanner control unit 51 in the device control layer 50 and therefore does not require a filter-specific low-level service.

The permanently stored information is a schema, such as default setting information (e.g., default execution conditions), of a filter and is stored in a non-volatile memory. A schema of a filter is registered in the data management unit 42 when the filter is installed.

FIG. 6 is a drawing illustrating components of the activity 31. As shown in FIG. 6, each activity 31 includes an activity UI, an activity logic program, and permanently stored information.

The activity UI is a program or data for displaying a screen for setting execution conditions of the activity 31, for example, on an operations panel.

The activity logic program performs the task of the activity 31 or defines a process to be performed by the activity 31. Normally, the activity logic program defines a combination of filters, the execution sequence of the filters, execution conditions common to multiple filters, filter connection rules, an error-handling process, etc. In the case of a linkage activity, the activity logic program defines information necessary to execute and link multiple activities 31.

The permanently stored information is a schema, such as default setting information (e.g., default execution conditions), of the activity 31 and is stored in a non-volatile memory. A schema of the activity 31 is registered in the data management unit 42 when the activity 31 is installed.

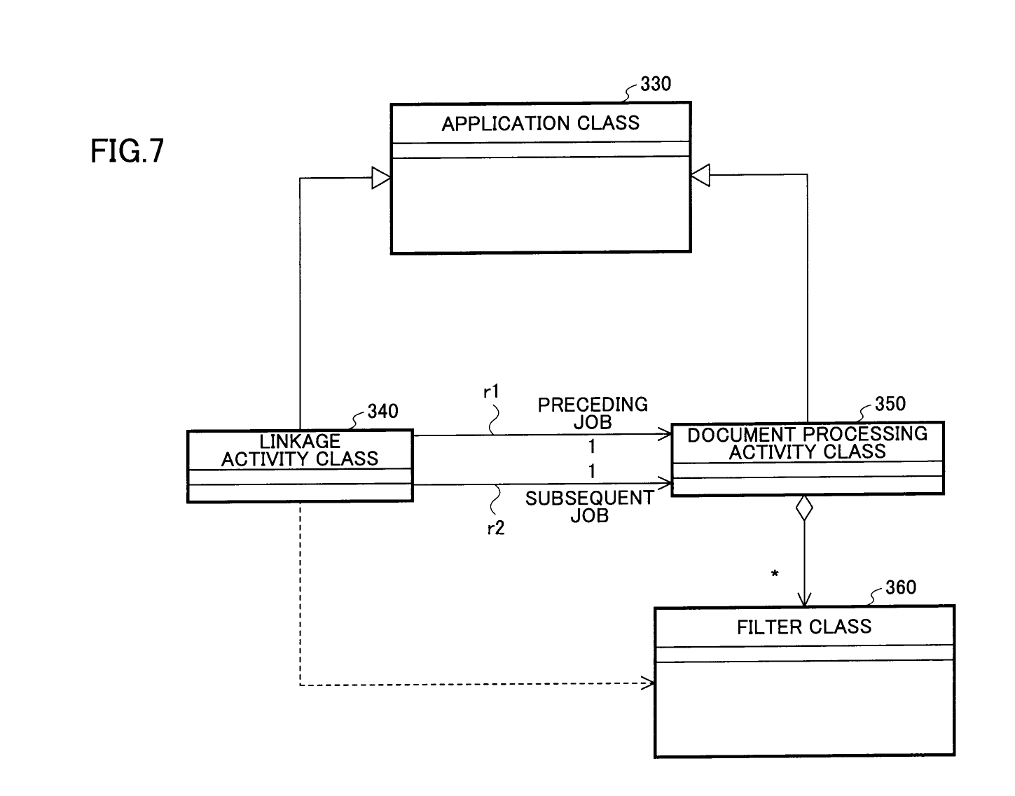

The activities 31 and filters are treated as objects in an application. Objects are described in a class structure. FIG. 7 is a drawing illustrating a class structure of activities and filters according to a first embodiment of the present invention.

In FIG. 7, an application class 330 is an abstract representation of both linkage and document processing activities. A linkage activity class 340 represents a linkage activity. Hereafter, an instance of the linkage activity class 340 is called a linkage activity object 340A. A document processing activity class 350 represents a document processing activity. Hereafter, an instance of the document processing activity class 350 is called a document processing activity object 350A. Filter classes 360 represent filters. Hereafter, an instance of a filter class 360 is called a filter object 360A.

The linkage activity class 340 and the document processing activity class 350 inherit the application class 330. Therefore, a linkage activity and a document processing activity can be handled using an interface defined in the application class 330 without taking into account their differences.

The linkage activity class 340 has relationships r1 and r2 (indicating logical connections) with (document processing activity objects 350A of) the document processing activity class 350. The relationship r1 shows a connection with a first document processing activity object 350A corresponding to a preceding one (that is to be executed first) of two document processing activities to be linked by the linkage activity. The first document processing activity object 350A is identified by a role name “preceding job”. The relationship r2 shows a connection with a second document processing activity object 350A corresponding to a subsequent one (that is to be executed next) of the two document processing activities to be linked by the linkage activity. The second document processing activity object 350A is identified by a role name “subsequent job”.

The document processing activity class 350 “aggregates” multiple filter classes 360. This indicates that each document processing activity comprises multiple filters.

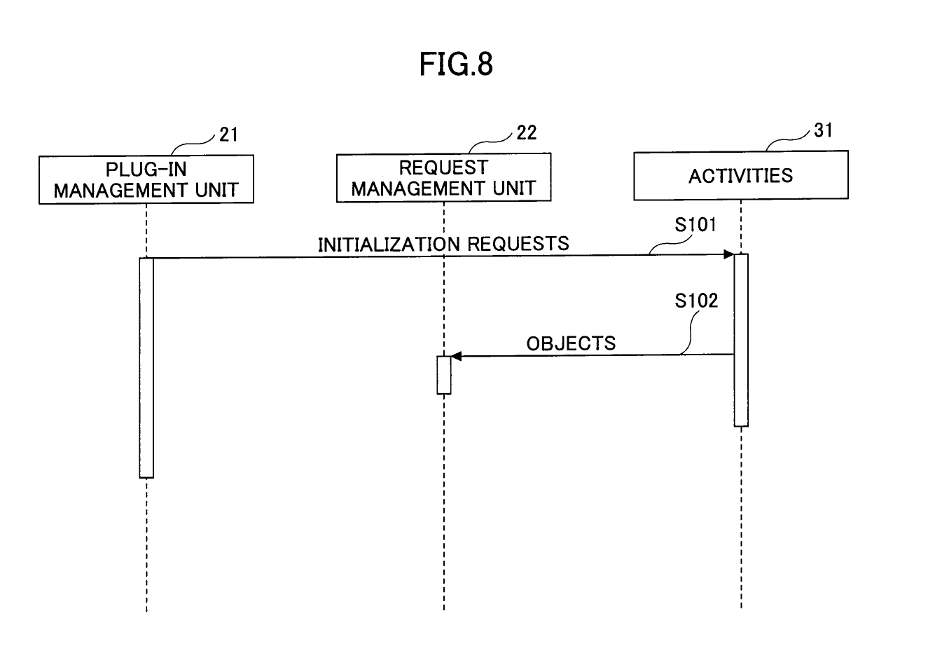

Exemplary processes in the multifunction copier 1 are described below. FIG. 8 is a sequence chart showing an initialization process of activities. The initialization process shown in FIG. 8 is performed before execution of the activities 31 is requested, for example, at the start-up of the multifunction copier 1 or when displaying a list of available activities 31 is requested.

The plug-in management unit 21 sends initialization requests to the activities 31 installed in the multifunction copier 1 (S101). A list of the activities 31 installed is stored in a storage unit of the multifunction copier 1. The plug-in management unit 21 obtains the list of the activities 31 and sends initialization requests to the activities 31 based on the list.

When receiving the initialization requests, the activities 31 generate the corresponding document processing activity objects 350A or the corresponding linkage activity objects 340A, and register the generated objects with the request management unit 22 (S102). The request management unit 22 handles the activities 31 using the registered objects.

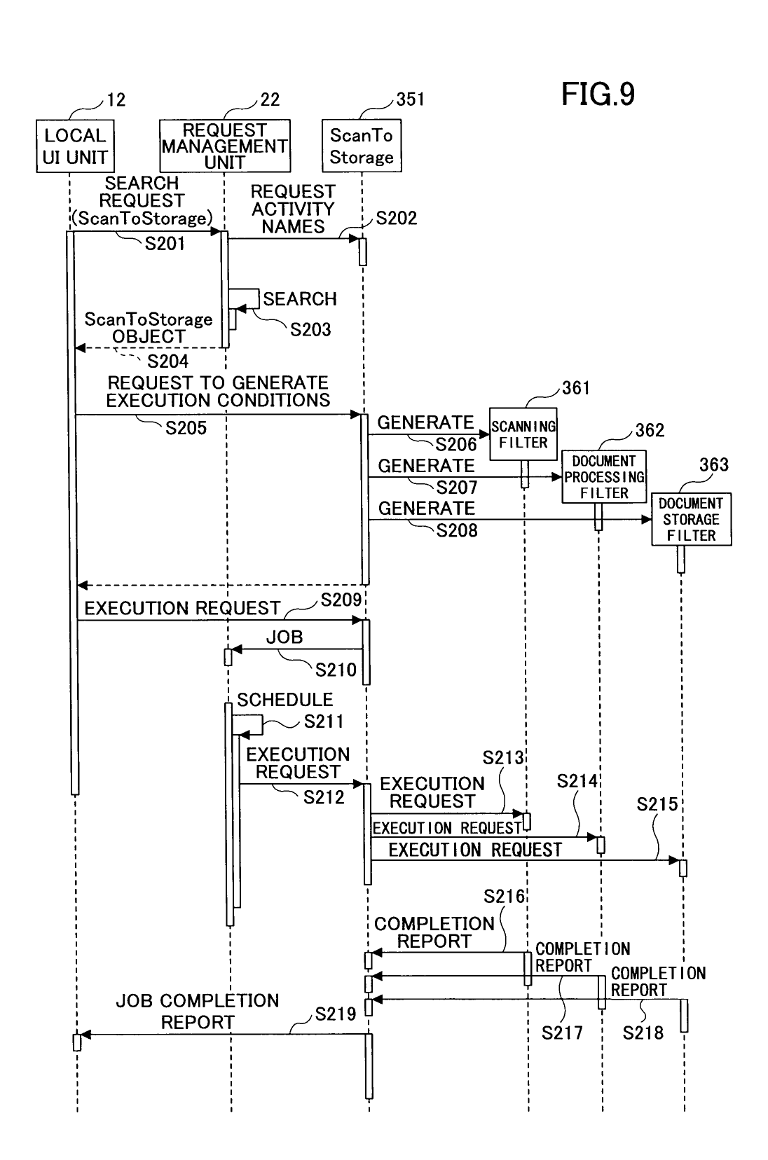

FIG. 9 is a sequence chart showing an execution process of a document processing activity. In the execution process shown in FIG. 9, the ScanToStorage activity 31a is used as an example of a document processing activity. In FIG. 9, a ScanToStorage object 351 indicates the document processing activity object 350A of the ScanToStorage activity 31a. Also, a scanning filter object 361, a document processing filter object 362, and a document storage filter object 363 indicate, respectively, the filter objects 360A of the scanning filter 301, the document processing filter 311, and the document storage filter 322. An object of an activity 31 performs its task according to the activity logic program (see FIG. 6) of the activity 31. An object of a filter performs its task according to the filter logic program (see FIG. 5) of the filter.

When the user selects the ScanToStorage activity 31a to be executed on the operations panel of the multifunction copier 1, the local UI unit 12 sends a search request with the name “ScanToStorage” of the ScanToStorage activity 31a to the request management unit 22 (S201). The request management unit 22 requests the objects (the document processing activity objects 350A and the linkage activity objects 340A) registered as shown in FIG. 8 to return the names of their respective activities 31 (S202).

Then, the request management unit 22 searches the names returned from the objects for the name “ScanToStorage” specified in the search request from the local UI 12 to determine whether the ScanToStorage activity 31a exists (S203). If the ScanToStorage activity 31a exists, the request management unit 22 returns the ScanToStorage object 351 of the ScanToStorage activity 31a to the local UI unit 12 (S204).

Next, the local UI unit 12 requests the ScanToStorage object 351 to generate execution conditions (S205). The ScanToStorage object 351 generates the scanning filter object 361, the document processing filter object 362, and the document storage filter object 363 of the corresponding filters constituting the ScanToStorage activity 31a (S206, S207, and S208), and sets default execution conditions of the ScanToStorage activity 31a and the constituent filters. The default execution conditions are, for example, included in the permanently stored information (see FIGS. 5 and 6) of each of the activity and filters.

The local UI unit 12 calls the activity UI (see FIG. 6) of the ScanToStorage activity 31a to obtain its screen information, and displays a ScanToStorage setting screen on the operations panel based on the screen information.

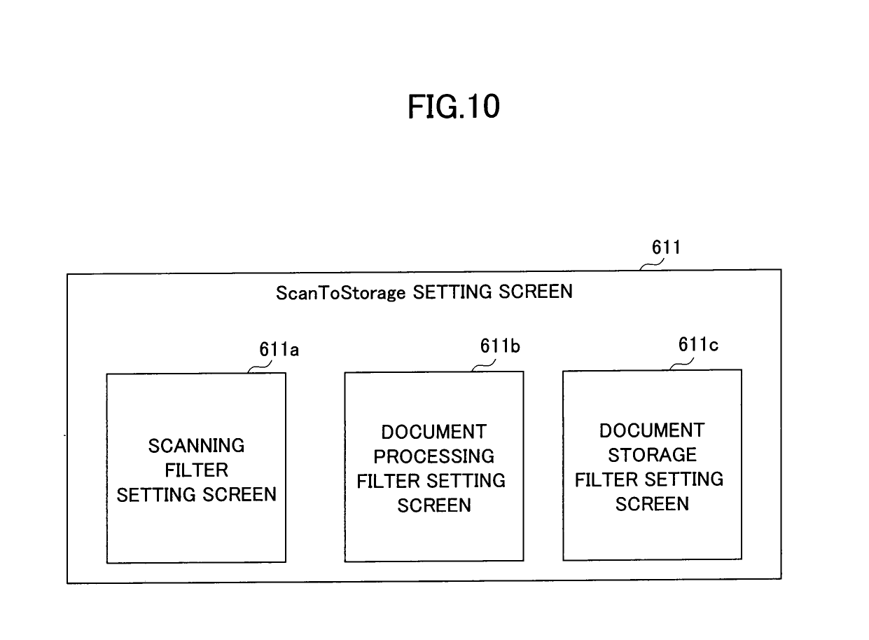

FIG. 10 is a drawing illustrating a ScanToStorage setting screen 611. The ScanToStorage setting screen 611 is used to set execution conditions of the ScanToStorage activity 31a. As shown in FIG. 10, the ScanToStorage setting screen 611 includes a scanning filter setting screen 611a, a document processing filter setting screen 611b, and a document storage filter setting screen 611c of the corresponding filters constituting the ScanToStorage activity 31a. The execution conditions of the ScanToStorage activity 31a are set up by setting up the execution conditions of the constituent filters. The activity UI of the ScanToStorage activity 31a, when called by the local UI unit 12, obtains screen information of the constituent filters by calling the corresponding filter UIs (see FIG. 5). The obtained screen information of the constituent filters is merged with the screen information of the ScanToStorage activity 31a. In the example shown in FIG. 10, the filter setting screens of the constituent filters are displayed separately in the ScanToStorage setting screen 611. Alternatively, the ScanToStorage setting screen 611 may be configured to display a consolidated setting screen for collectively setting execution conditions of the constituent filters.

Execution conditions specified in the filter setting screens are set in the filter logic programs (see FIG. 5) of the corresponding filters.

Thus, in this embodiment, a user interface for setting execution conditions is implemented in each filter and can be called from any activity 31 using the filter. This architecture eliminates the need to develop user interfaces for each application (the activity 31) and thereby makes it possible to improve development efficiency.

Referring back to FIG. 9, when the user enters a request to execute the ScanToStorage activity 31a from the operations panel, the local UI unit 12 sends an execution request to the ScanToStorage object 351 (S209). Then, the ScanToStorage object 351 connects the scanning filter 301, the document processing filter 311, and the document storage filter 322 constituting the ScanToStorage activity 31a by pipes in the specified execution sequence, and puts the process to be performed by the ScanToStorage activity 31a as a job in a job queue of the request management unit 22 (S210). “Connecting filters by pipes” means to send information identifying input and output pipes (e.g., file names or memory addresses representing the input and output pipes) to each filter. Based on the information, each filter identifies input and output pipes, i.e., an input source and a destination of data.

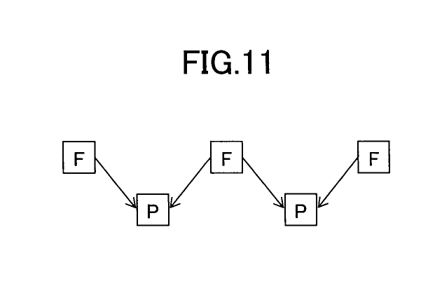

FIG. 11 is a schematic diagram illustrating filters connected by pipes. In FIG. 11, “F” indicates a filter and “P” indicates a pipe.

There are various types of pipes that are used depending on the filters to be connected. Therefore, it is necessary to determine the type of a pipe to be used to connect a certain pair of filters. The types of pipes may be defined in the activity logic program of the activity 31 or may be defined as a table in a storage unit of the multifunction copier 1.

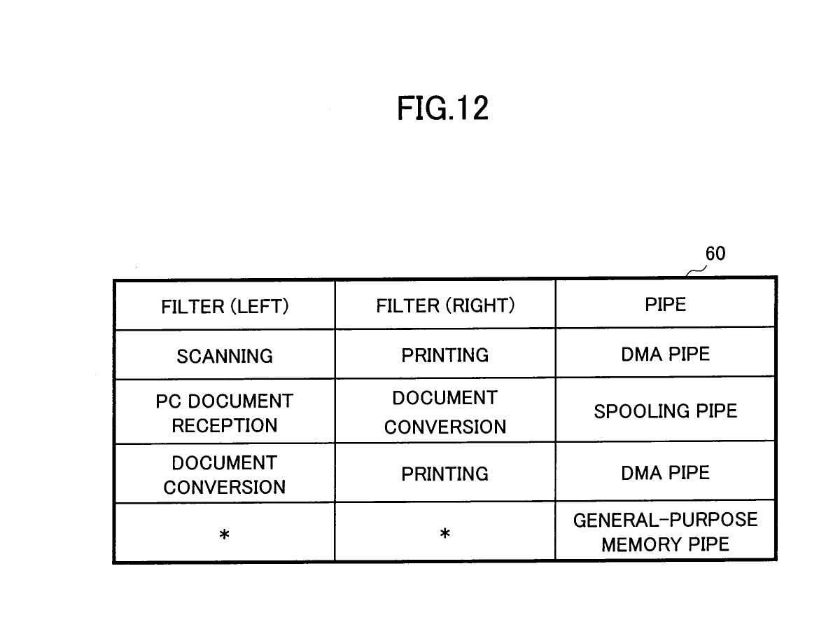

FIG. 12 is a table showing exemplary correspondence between filters and pipes. According to a correspondence table 60 shown in FIG. 12, a direct memory access (DMA) pipe for high-speed data transmission is used between the scanning filter 301 and the printing filter 321 and between the document conversion filter 312 and the printing filter 321. A spooling pipe is used between the PC document reception filter 305 and the document conversion filter 312. The spooling pipe spools data output from a left-hand filter in an HDD until a right-hand filter reads the data. Other pairs of filters are connected by a general-purpose memory pipe. The general-purpose memory pipe uses a RAM buffer with a finite size to transfer data between filters. The correspondence table 60 can be edited according to addition and removal of filters and pipes. The image pipe 41 shown in FIG. 1 is an abstract representation of modules providing interfaces to various types of pipes.

Referring back to FIG. 9, the request management unit 22 schedules the job put in the job queue (S211). When the turn of the ScanToStorage activity 31a comes, the request management unit 22 sends an execution request to the ScanToStorage object 351 (S212). The ScanToStorage object 351 sends execution requests concurrently to the scanning filter object 361, the document processing filter object 362, and the document storage filter object 363 (the filter objects 360A) of the filters constituting the ScanToStorage activity 31a (S213, S214, and S215). Thus, filters in an activity are called at substantially the same time without waiting for the completion of preceding filters. The simultaneously-called filters are synchronized by pipes. When receiving an execution request, a filter waits until data are input to its input pipe. As an exception, no input pipe is provided for an input filter. Therefore, an input filter starts a process as soon as it receives an execution request.

In the example shown in FIG. 9, the scanning filter 301 controls the process of scanning an image by a scanner and outputs the scanned image data to its output pipe. When detecting input of the image data to the input pipe (the output pipe of the scanning filter 301), the document processing filter 311 performs image processing according to the execution conditions on the image data and outputs the processed image data to its output pipe. When detecting input of the processed image data to the input pipe (the output pipe of the document processing filter 311), the document storage filter 322 stores the processed image data in a hard disk. Thus, a process of scanning an image and storing the scanned image data is performed by the ScanToStorage activity 31a.

The filter objects 361, 362, and 363 send completion reports to the ScanToStorage object 351 when their respective processes are completed (S216, S217, and S218). After receiving the completion reports from all of the filter objects 361, 362, and 363, the ScanToStorage object 351 sends a job completion report to the local UI unit 12 (S219).

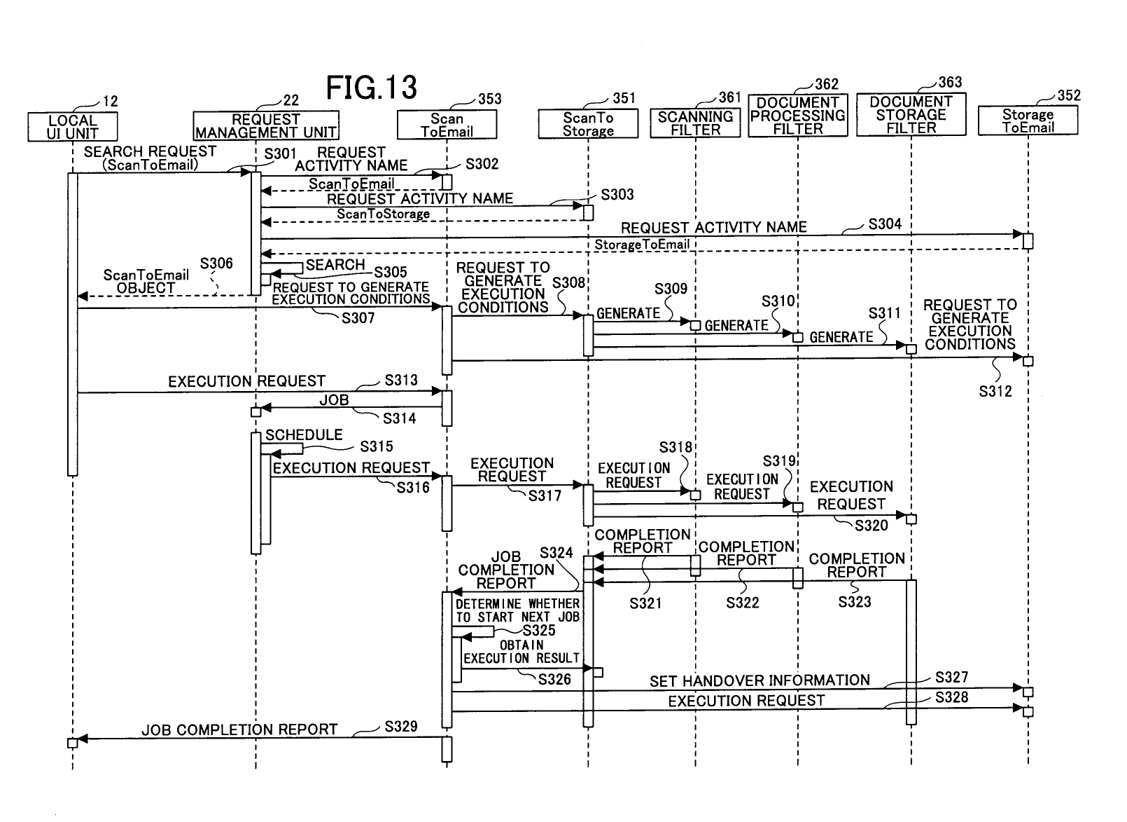

An execution process of a linkage activity is described below. FIG. 13 is a sequence chart showing an exemplary execution process of a linkage activity. In the execution process shown in FIG. 13, the ScanToEmail activity 31c is used as an example of a linkage activity. In FIG. 13, components corresponding to those shown in FIG. 9 are assigned the same reference numbers. In FIG. 13, a ScanToEmail object 353 indicates the linkage activity object 340A of the ScanToEmail activity 31c. Also, a StorageToEmail object 352 indicates the document processing activity object 350A of the StorageToEmail activity 31b.

When the user selects the ScanToEmail activity 31c to be executed on the operations panel of the multifunction copier 1, the local UI unit 12 sends a search request with the name “ScanToEmail” of the ScanToEmail activity 31c to the request management unit 22 (S301). The request management unit 22 requests the objects (the document processing activity objects 350A and the linkage activity objects 340A) registered as shown in FIG. 8 to return the names of their respective activities 31 (S302, S303, and S304).

Then, the request management unit 22 searches the names returned from the objects for the name “ScanToEmail” specified in the search request from the local UI 12 to determine whether the ScanToEmail activity 31c exists (S305). In this step, if the activity 31 to be searched for is a linkage activity, the request management unit 22 identifies document processing activities to be linked by the linkage activity based on linkage definition information associated with the linkage activity, and determines whether the identified document processing activities also exist. The linkage definition information is, for example, stored in a storage unit of the multifunction copier 1.

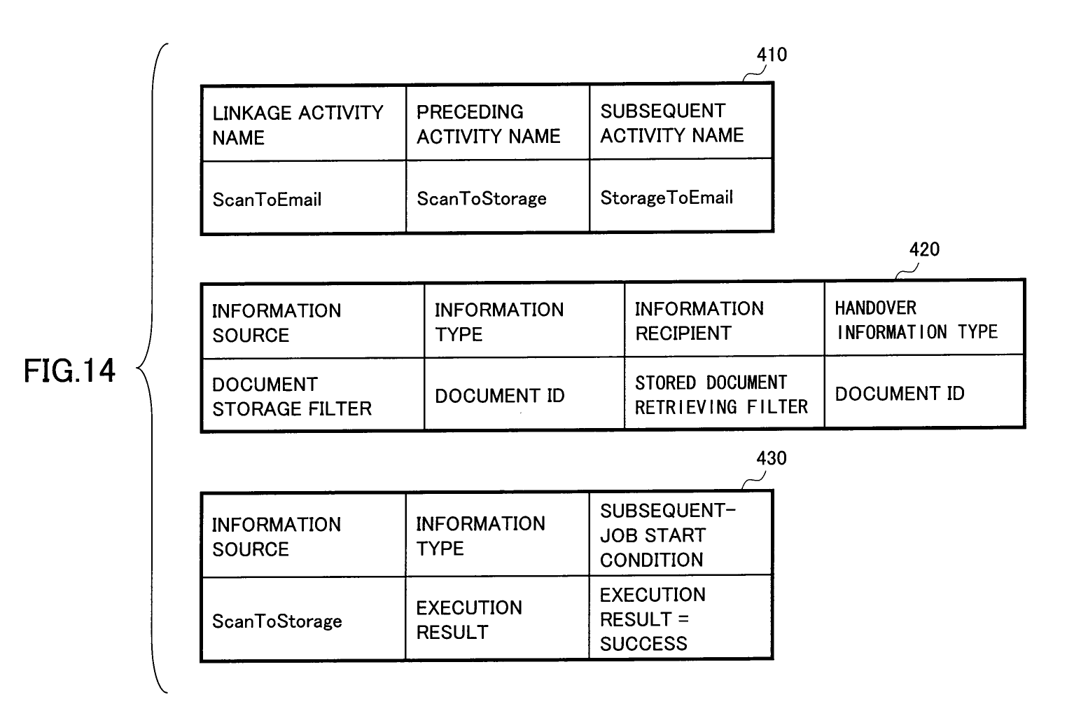

FIG. 14 is a drawing showing linkage definition information of the ScanToEmail activity 31c that is a linkage activity. As shown in FIG. 14, the linkage definition information includes structure information 410, handover setting information 420, and subsequent-job starting information 430. In S305 described above, the structure information 410 is used. The structure information 410 includes a linkage activity name, a preceding activity name, and a subsequent activity name. The linkage activity name is the name of a linkage activity with which the linkage definition information is associated. The preceding activity name is the name of a preceding one (that is to be executed first) of document processing activities to be linked by the linkage activity. The subsequent activity name is the name of a subsequent one (that is to be executed next) of the document processing activities to be linked by the linkage activity. In step S305, based on the structure information 410, the request management unit 22 determines the presence of not only the ScanToEmail activity 31c but also the ScanToStorage activity 31a and the StorageToEmail activity 31b to be linked by the ScanToEmail activity 31c. The linkage definition information may be stored as a part of the permanently stored information of the linkage activity, or as a file in a storage unit of the multifunction copier 1.

Referring back to FIG. 13, if the ScanToEmail activity 31c, and the ScanToStorage activity 31a and the StorageToEmail activity 31b to be linked by the ScanToEmail activity 31c all exist, the request management unit 22 returns the ScanToEmail object 353 of the ScanToEmail activity 31c to the local UI unit 12 (S306).

Next, the local UI unit 12 requests the ScanToEmail object 353 to generate execution conditions (S307). The ScanToEmail object 353 sets default execution conditions of the ScanToEmail activity 31c, and requests the ScanToStorage object 351 of the ScanToStorage activity 31a and the StorageToEmail object 352 of the StorageToEmail activity 31b to generate their execution conditions (S308 and S312). In this step, the ScanToEmail object 353 identifies the ScanToStorage activity 31a and the StorageToEmail activity 31b constituting the ScanToEmail activity 31c based on the structure information 410.

The ScanToStorage object 351 and the StorageToEmail object 352 set default execution conditions of the corresponding activities 31 and their constituent filters. In FIG. 13, the ScanToStorage object 351 generates the scanning filter object 361, the document processing filter object 362, and the document storage filter object 363 of the corresponding filters constituting the ScanToStorage activity 31a, and sets default execution conditions of the constituent filters (S309, S310, and S311). The StorageToEmail object 352 also generates filter objects of filters constituting the StorageToEmail activity 31b and sets default execution conditions of the filters. For brevity, those steps are omitted in FIG. 13.

Then, the local UI unit 12 calls the activity UI of the ScanToEmail activity 31c to obtain screen information of the ScanToStorage activity 31c, and displays a ScanToEmail setting screen on the operations panel based on the screen information.

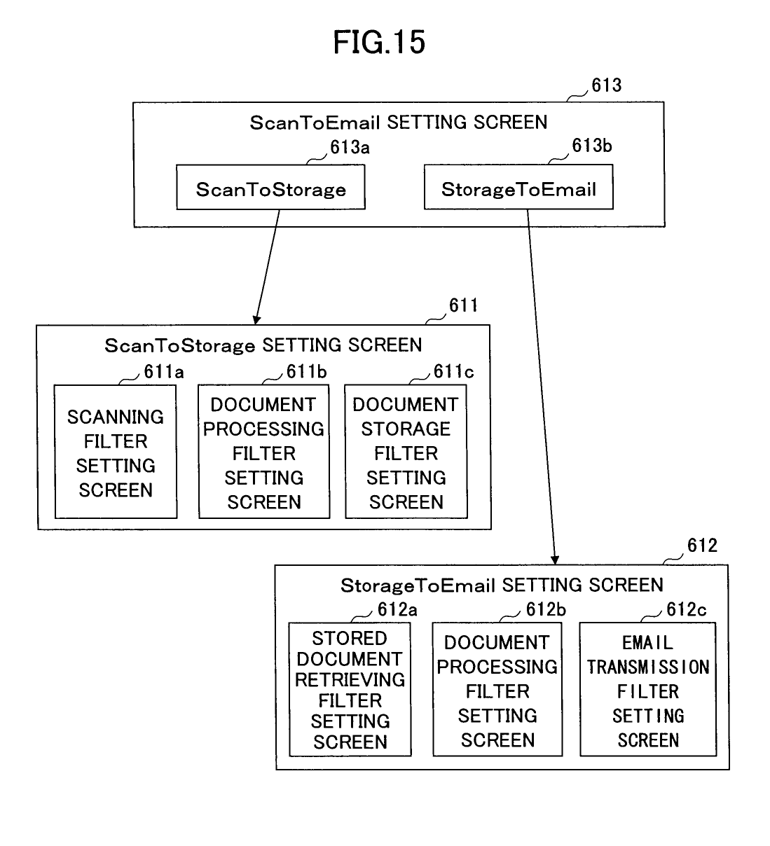

FIG. 15 is a drawing illustrating a ScanToEmail setting screen 613. As shown in FIG. 15, the ScanToEmail setting screen 613 includes a ScanToStorage button 613a corresponding to the ScanToStorage activity 31a and a StorageToEmail button 613b corresponding to the StorageToEmail activity 31b. Thus, a setting screen of a linkage activity includes buttons corresponding to the activities 31 to be linked by the linkage activity.

When the ScanToStorage button 613a is selected (or touched) on the ScanToEmail setting screen 613, the local UI unit 12 calls the activity UI of the ScanToStorage activity 31a to obtain screen information of the ScanToStorage activity 31a, and displays the ScanToStorage setting screen 611 based on the screen information.

When the StorageToEmail button 613b is selected, the local UI unit 12 calls the activity UI of the StorageToEmail activity 31b to obtain screen information of the StorageToEmail activity 31b, and displays a StorageToEmail setting screen 612 based on the screen information. Similar to the ScanToStorage activity setting screen 611, the StorageToEmail activity setting screen 612 includes a stored document retrieving filter setting screen 612a, a document processing filter setting screen 612b, and an email transmission filter setting screen 612c of the corresponding filters constituting the StorageToEmail activity 31b.

Execution conditions specified in the filter setting screens are set in the filter logic programs (see FIG. 5) of the corresponding filters.

When the StorageToEmail activity 31b is executed alone, the stored document retrieving filter setting screen 612a of the StorageToEmail activity setting screen 612 requests the user to select document data (image data) stored in a storage unit of the multifunction copier 1. However, in the ScanToEmail activity 31c, document data are input to the StorageToEmail activity 31b from the ScanToStorage activity 31a. Therefore, there is no need to request the user to select document data, and there is no need to display the stored document retrieving filter setting screen 612a. Alternatively, the stored document retrieving filter setting screen 612a may be displayed with a menu for selecting document data disabled. In this case, the ScanToEmail activity 31c may be configured to disable the menu for selecting document data on the stored document retrieving filter setting screen 612a.

Referring back to FIG. 13, when the user enters a request to execute the ScanToEmail activity 31c from the operations panel, the local UI unit 12 sends an execution request to the ScanToEmail object 353 (S313). The ScanToEmail object 353 puts the process to be performed by the ScanToEmail activity 31c as a job in a job queue of the request management unit 22 (S314).

The request management unit 22 schedules the job put in the job queue (S315). When the turn of the ScanToEmail activity 31c comes, the request management unit 22 sends an execution request to the ScanToEmail object 353 (S316). The ScanToEmail object 353 sends an execution request to the ScanToStorage object 351 corresponding to the preceding activity name in the structure information 410 (S317). Then, the ScanToStorage activity 31a is executed in steps S318 through S323 in a manner similar to steps S213 through S218 of FIG. 9. After receiving completion reports from all of the filter objects 361, 362, and 363 (S321, S322, and S323), the ScanToStorage object 351 sends a job completion report of the ScanToStorage activity 31a to the ScanToEmail object 353 (S324).

The ScanToEmail object 353 determines whether to start a subsequent job (the job of the StorageToEmail activity 31b) based on the subsequent-job starting information 430. As shown in FIG. 14, the subsequent-job starting information 430 includes an information source, an information type, and a subsequent-job start condition. The information source is an identifier of an information source from which information (decision information) for determining whether to start the subsequent job is obtained. The decision information is, for example, a status such as the execution result of a preceding job (or a preceding activity). In FIG. 14, the ScanToStorage activity 31a is specified as the information source. The information type is the type of information to be obtained as the decision information. In FIG. 14, the execution result (success or failure) of the ScanToStorage activity 31a is specified as the information type. The subsequent-job start condition is the condition to start the subsequent job. In FIG. 14, the subsequent job is started if the execution result is a success.

Based on the information source and the information type in the subsequent-job starting information 430, the ScanToEmail object 353 obtains the execution result of the ScanToStorage activity 31a from the ScanToStorage object 351 (S326) and compares the execution result with the subsequent-job start condition.

If the execution result is a failure (if the subsequent-job start condition is not satisfied), the ScanToEmail object 353 does not execute the StorageToEmail activity 31b. If the execution result is a success (if the subsequent-job start condition is satisfied), the ScanToEmail object 353 obtains handover information based on handover setting information 420 of the linkage definition information and sets the handover information as an execution condition of the StorageToEmail activity 31b (S327).

“Handover information” indicates information to be handed over to a subsequent activity 31 from a preceding activity 31. As shown in FIG. 14, the handover setting information 420 includes an information source, an information type, an information recipient, and an execution condition type. The information source is an identifier of an information source from which handover information is obtained. In FIG. 14, the document storage filter 322 (the output filter of the ScanToStorage activity 31a) is specified as the information source. The information type is the type of information to be obtained from the information source. In FIG. 14, a document ID (an ID of image data stored by the document storage filter 322) is specified as the information type. The information recipient indicates a recipient of handover information. In FIG. 14, the stored document retrieving filter 302 (the input filter of the StorageToEmail activity 31b) is specified as the information recipient. The execution condition type is the type of an execution condition of the information recipient to be set based on the handover information. In FIG. 14, a document ID is specified as the execution condition type.

Based on the handover setting information 420 shown in FIG. 14, the ScanToEmail object 353 obtains a document ID of stored image data from the document storage filter 322 of the ScanToStorage activity 31a, and sets the obtained document ID as an execution condition of the stored document retrieving filter 302 of the StorageToEmail activity 31b.

Next, the ScanToEmail object 353 sends an execution request to the StorageToEmail object 352 (S328). In response to the execution request, the StorageToEmail activity 31b (or the StorageToEmail object 352) sends the image data corresponding to the document ID as an email message. The execution process of the StorageToEmail activity 31b is similar to that of the ScanToStorage activity 31a and is therefore omitted in FIG. 13.

When a completion report is sent from the StorageToEmail object 352, the ScanToEmail object 353 sends a job completion report of the ScanToEmail activity 31c to the local UI unit 12 (S329). Thus, the ScanToEmail activity 31c executes the ScanToStorage activity 31a and the StorageToEmail activity 31b in sequence and thereby performs a process of scanning an image and sending the scanned image data as an email message.

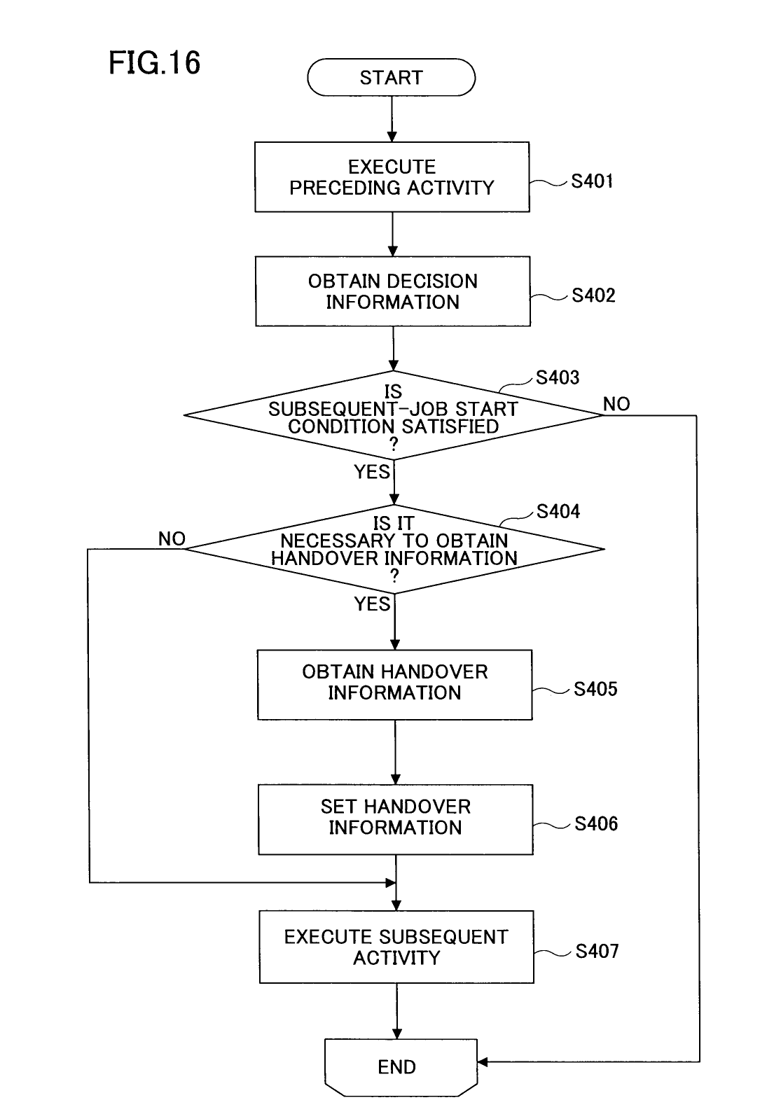

In the above descriptions, an execution process of a linkage activity is exemplified using the ScanToEmail activity 31c. Next, an execution process of a linkage activity is described in a more general manner using a flowchart. FIG. 16 is a flowchart showing an execution process of a linkage activity.

First, a preceding activity 31 is executed based on the preceding activity name in the structure information 410 (S401). Step 401 corresponds to step S317 in FIG. 13.

Next, decision information is obtained based on the information source and the information type in the subsequent-job starting information 430 (S402). Then, based on the decision information, it is determined whether the subsequent-job start condition in the subsequent-job starting information 430 is satisfied (S403). If the subsequent-job start condition is not satisfied (NO in S403), the subsequent activity 31 is not executed.

If the subsequent-job start condition is satisfied (YES in S403), whether it is necessary to obtain handover information is determined based on the handover setting information 420 (S404). More specifically, it is determined whether the handover setting information 420 is provided for the linkage activity. If obtaining handover information is necessary (if the handover setting information 420 is provided for the linkage activity) (YES in S404), the handover information is obtained from the information source based on the handover setting information 420 (S405), and the obtained handover information is set as an execution condition of the information recipient (S406). If obtaining handover information is not necessary (if the handover setting information 420 is not provided for the linkage activity) (NO in S404), the handover information is not obtained.

Next, the subsequent activity 31 is executed based on the subsequent activity name in the structure information 410 (S407).

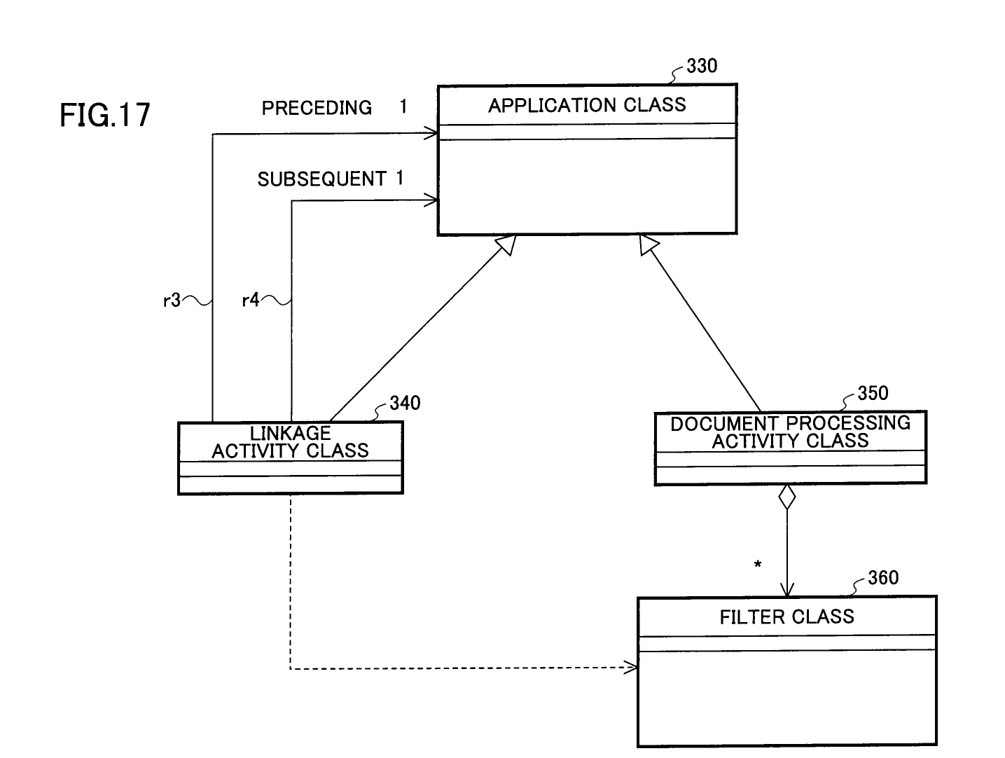

A second embodiment of the present invention is described below. FIG. 17 is a drawing illustrating a class structure of activities and filters according to the second embodiment of the present invention. In FIG. 17, components corresponding to those shown in FIG. 7 are assigned the same reference numbers and descriptions of those components are omitted.

In FIG. 17, the linkage activity class 340 has relationships r3 and r4 (indicating logical connections) with the application class 330 instead of the relationships r1 and r2 shown in FIG. 7. The relationship r3 shows a connection with a linkage activity object 340A or a document processing activity object 350A corresponding to a preceding one (that is to be executed first) of two activities 31 to be linked. The relationship r4 shows a connection with a linkage activity object 340A or a document processing activity object 350A corresponding to a subsequent one (that is to be executed next) of the two activities 31 to be linked.

Thus, in this embodiment, a linkage activity itself can be linked with another activity. A linkage activity linking a combination of linkage and document processing activities executes the linked activities in sequence.

Take, for example, a case where one of the two document processing activity objects 350A (the ScanToStorage object 351 and the StorageToEmail object 352) in the sequence chart of FIG. 13 is replaced with a linkage activity object 340A. The linkage activity object 340A replacing one of the two document processing activity objects 350A is executed in a manner similar to the ScanToEmail object 353 shown in FIG. 13. In other words, the linkage activity object 340A executes constituent activities in a hierarchical fashion as the ScanToEmail object 353 does in FIG. 13.

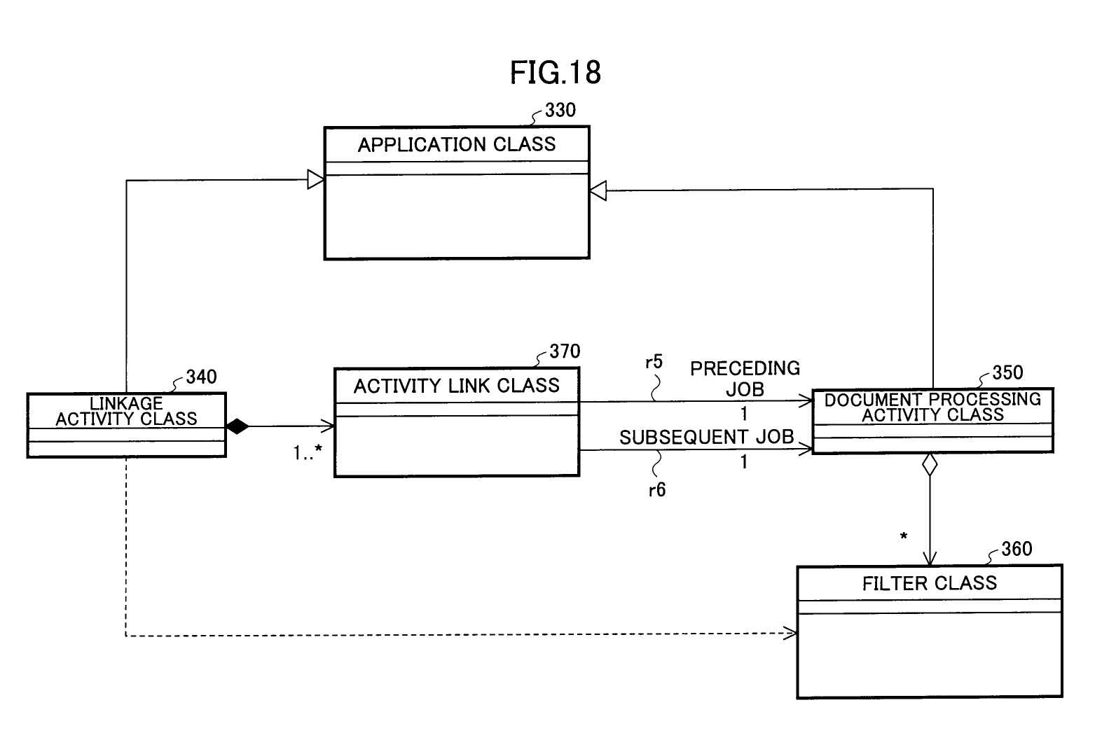

A third embodiment of the present invention is described below. FIG. 18 is a drawing illustrating a class structure of activities and filters according to the third embodiment of the present invention. In FIG. 18, components corresponding to those shown in FIG. 7 are assigned the same reference numbers and descriptions of those components are omitted.

In the class structure of FIG. 18, an activity link class 370 is added. The activity link class 370 maintains relationships between the linkage activity class 340 and the document processing activity class 350. Hereafter, an instance of the activity link class 370 is called an activity link object 370A.

The activity link class 370 has relationships r5 and r6 with the document processing activity class 350. The relationship r5 shows a connection with a first document processing activity object 350A corresponding to a preceding one (that is to be executed first) of two document processing activities to be linked. The first document processing activity object 350A is identified by a role name “preceding job”. The relationship r6 shows a connection with a second document processing activity object 350A corresponding to a subsequent one (that is to be executed next) of the two document processing activities to be linked. The second document processing activity object 350A is identified by a role name “subsequent job”.

The linkage activity class 340 has a one-to-many (1 . . . *) relationship with the activity link class 370.

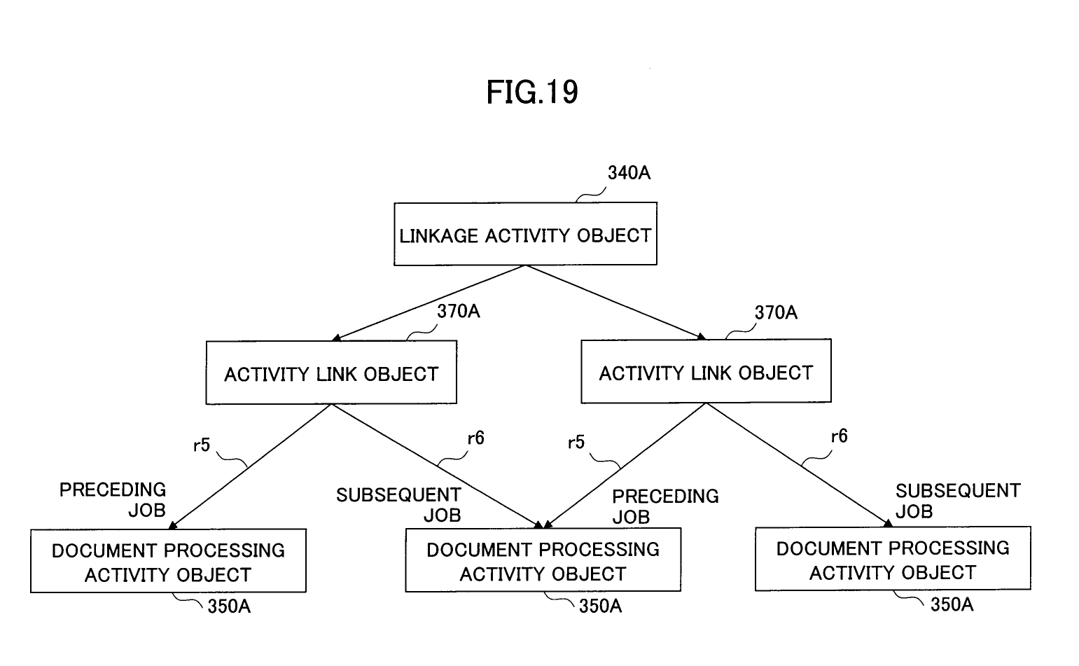

FIG. 19 is an object diagram illustrating a relationship between a linkage activity and document processing activities according to the third embodiment of the present invention. In FIG. 19, one linkage activity object 340A aggregates two activity link objects 370A. Each of the activity link objects 370A is connected with two document processing activity objects 350A by the relationships r5 and r6. In this diagram, a document processing activity object 350A forming a subsequent job of one of the activity link objects 370A forms a preceding job of the other one of the activity link objects 370A. Thus, in FIG. 19, one linkage activity object 340A is connected via two activity link objects 370A with three document processing activity objects 350A. In other words, with a class structure as shown in FIG. 18, it is possible to link three or more document processing activities by one linkage activity.

Meanwhile, in the structure information 420 shown in FIG. 14, the number of fields (the preceding activity name and the subsequent activity name) for storing activity names is fixed. When constructing a class structure as shown in FIG. 18, the structure information 420 is preferably designed to allow addition of fields for storing activity names according to the number of activities 31 to be linked.

The third and subsequent activities in a linkage activity according to the third embodiment can be executed by repeating the steps of executing the subsequent activity (StorageToEmail activity 31b) as shown in FIG. 13.

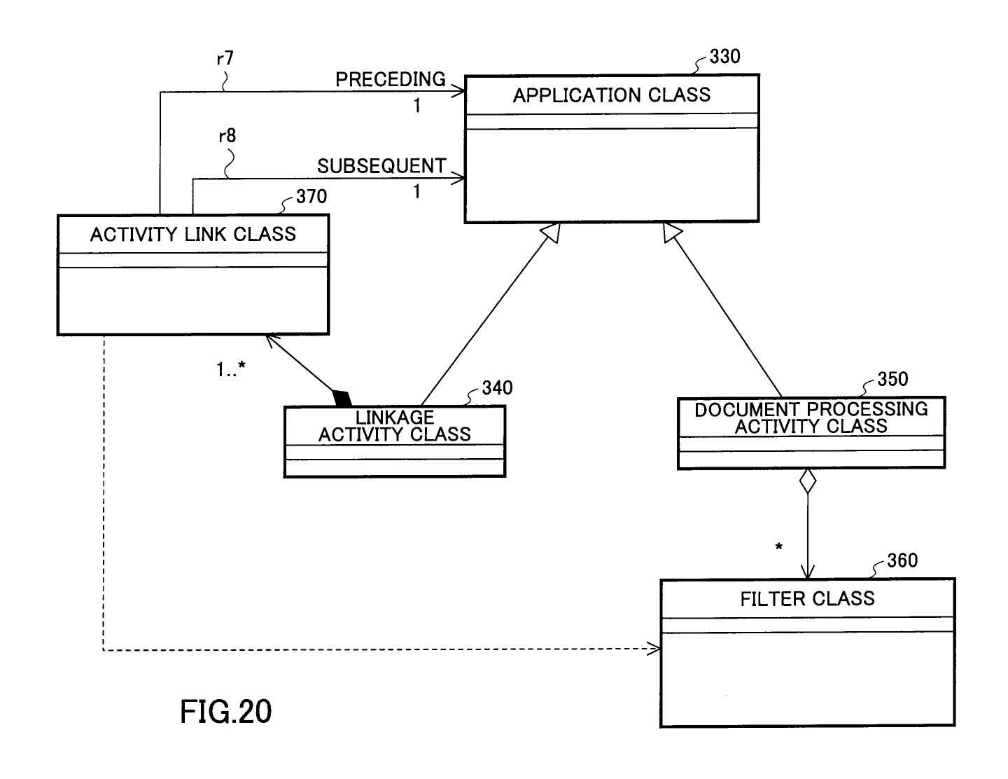

A fourth embodiment of the present invention is described below. FIG. 20 is a drawing illustrating a class structure of activities and filters according to the fourth embodiment of the present invention. In FIG. 20, components corresponding to those shown in FIG. 18 are assigned the same reference numbers and descriptions of those components are omitted.

In FIG. 20, the activity link class 370 has relationships r7 and r8 with the application class 330 instead of the relationships r5 and r6 shown in FIG. 18. The relationship r7 shows a connection with a linkage activity object 340A or a document processing activity object 350A corresponding to a preceding one (that is to be executed first) of two activities 31 to be linked by the activity link object 370A. The relationship r8 shows a connection with a linkage activity object 340A or a document processing activity object 350A corresponding to a subsequent one (that is to be executed next) of the two activities 31 to be linked by the activity link object 370A.

Thus, in this embodiment, a linkage activity itself can be linked with another activity via the activity link object 370A. In other words, the fourth embodiment is a combination of the second and third embodiments and makes it possible to link three or more linkage and document processing activities by one linkage activity.

A linkage activity of the fourth embodiment can be executed by modifying a process shown in FIG. 13 as described in the second and third embodiments.

As described above, the multifunction copier 1 according to embodiments of the present invention makes it possible to link multiple activities each comprising independent filters, and thereby makes it possible to flexibly and efficiently develop applications.

An embodiment of the present invention makes it possible to determine whether to execute a subsequent activity based on a status such as the execution result of a preceding activity and thereby makes it possible to flexibly execute linked activities.

An embodiment of the present invention makes it possible to define an activity that performs a common process required by multiple activities and thereby makes it possible to efficiently develop applications.

For example, each activity requires an abnormal termination process, such as displaying an error message, which is to be performed if the activity ends abnormally. Incorporating such an abnormal termination process as a routine in each activity reduces application development efficiency and increases the maintenance workload. This problem can be solved by defining an abnormal termination activity for performing the abnormal termination process and linking the abnormal termination activity as a subsequent activity with other activities. In this case, the subsequent-job start condition for the abnormal termination activity is specified such that the abnormal termination activity is executed if the execution result of a preceding activity is a failure. Also, an error code may be used as the handover information.

Thus, embodiments of the present invention provide an image forming apparatus, an application execution method, and a storage medium containing program code for performing the application execution method that allow the user to easily customize or add functions of the image forming apparatus.

The present invention is not limited to the specifically disclosed embodiments, and variations and modifications may be made without departing from the scope of the present invention.

The present application is based on Japanese Priority Application No. 2007-149386, filed on Jun. 5, 2007, the entire contents of which are hereby incorporated herein by reference.

What is claimed is:

1. An image forming apparatus, comprising:
a storage unit storing a linkage application and processing applications, each of the processing applications being implemented by a combination of software components for inputting, processing, and outputting image data;
wherein the linkage application is configured to execute a combination of the processing applications in sequence.

2. The image forming apparatus as claimed in claim 1, wherein the linkage application is configured to obtain handover information from a preceding one of the processing applications of the combination and to set the obtained handover information as an execution condition of a subsequent one of the processing applications of the combination.

3. The image forming apparatus as claimed in claim 2, wherein the linkage application is configured to obtain the handover information from the preceding one of the processing applications of the combination which is specified as an information source in linkage definition information and to set the obtained handover information as the execution condition of the subsequent one of the processing applications of the combination which is specified as an information recipient in the linkage definition information.

4. The image forming apparatus as claimed in claim 1, wherein the linkage application is configured to determine whether to execute a subsequent one of the processing applications of the combination based on a status of a preceding one of the processing applications of the combination.

5. The image forming apparatus as claimed in claim 1, wherein the linkage application is configured to obtain decision information specified in linkage definition information from a preceding one of the processing applications of the combination and to determine whether to execute a subsequent one of the processing applications of the combination by comparing the obtained decision information with a condition specified in the linkage definition information.

6. The image forming apparatus as claimed in claim 1, wherein the linkage application is configured to execute a combination of a second linkage application and one or more of the processing applications or a combination of the second linkage application and a third linkage application in sequence.

7. A method of executing applications in an image forming apparatus where each of the applications is implemented by a combination of software components for inputting, processing, and outputting image data, the method comprising:
a linkage step of executing a combination of the applications in sequence.

8. The method as claimed in claim 7, wherein the linkage step includes the steps of
a) obtaining handover information from a preceding one of the applications of the combination; and
b) setting the obtained handover information as an execution condition of a subsequent one of the applications of the combination.

9. The method as claimed in claim 8, wherein
in step a), the handover information is obtained from the preceding one of the applications of the combination which is specified as an information source in linkage definition information; and
in step b), the obtained handover information is set as the execution condition of the subsequent one of the applications of the combination which is specified as an information recipient in the linkage definition information.

10. The method as claimed in claim 7, wherein the linkage step includes the step of
determining whether to execute a subsequent one of the applications of the combination based on a status of a preceding one of the applications of the combination.

11. The method as claimed in claim 7, wherein the linkage step includes the steps of
obtaining decision information specified in linkage definition information from a preceding one of the applications of the combination; and
determining whether to execute a subsequent one of the applications of the combination by comparing the obtained decision information with a condition specified in the linkage definition information.

12. The method as claimed in claim 7, wherein, in the linkage step, a combination of a second linkage step and one or more of the applications or a combination of the second linkage step and a third linkage step are executed in sequence.

13. A storage medium having program code embodied therein for causing an image forming apparatus to execute applications each of which is implemented by a combination of software components for inputting, processing, and outputting image data, the program code comprising:
a linkage code unit configured to execute a combination of the applications in sequence.

14. The storage medium as claimed in claim 13, wherein the linkage code unit is configured to obtain handover information from a preceding one of the applications of the combination and to set the obtained handover information as an execution condition of a subsequent one of the applications of the combination.

15. The storage medium as claimed in claim 14, wherein the linkage code unit is configured to obtain the handover information from the preceding one of the applications of the combination which is specified as an information source in linkage definition information and to set the obtained handover information as the execution condition of the subsequent one of the applications of the combination which is specified as an information recipient in the linkage definition information.

16. The storage medium as claimed in claim 13, wherein the linkage code unit is configured to determine whether to execute a subsequent one of the applications of the combination based on a status of a preceding one of the applications of the combination.

17. The storage medium as claimed in claim 13, wherein the linkage code unit is configured to obtain decision information specified in linkage definition information from a preceding one of the applications of the combination and to determine whether to execute a subsequent one of the applications of the combination by comparing the obtained decision information with a condition specified in the linkage definition information.

18. The storage medium as claimed in claim 13, wherein the linkage code unit is configured to execute a combination of a second linkage code unit and one or more of the applications or a combination of the second linkage code unit and a third linkage code unit in sequence.
